(19) United States
(12) Patent Application Publication
(10) Pub. No.: US 2026/0257967 A1
(43) Pub. Date: Sep. 3, 2026

(54) CHAR BRICKS AND METHODS OF MAKING CHAR BRICKS

(71) Applicant: UNIVERSITY OF WYOMING, Laramie, WY (US)

(72) Inventors: Kam Weng NG, Laramie, WY (US); Chooi Kim LAU, Laramie, WY (US); Hua YU, Laramie, WY (US)

(21) Appl. No.: 18/878,528

(22) PCT Filed: Jun. 23, 2023
(86) PCT No.: PCT/US2023/026075

§ 371 Date: Dec. 23, 2024

Related U.S. Application Data
(60) Provisional application No. 63/354,742, filed on Jun. 23, 2022.

(51) Int. Cl. C04B 18/06; C04B 14/06; C04B 16/06; C04B 18/08; C04B 20/10; C04B 22/10; C04B 24/26; C04B 24/38; C04B 28/04; C04B 40/00; C04B 103/32

(52) U.S. Cl. CPC C04B 18/065; C04B 14/06; C04B 16/0633; C04B 18/08; C04B 20/1077; C04B 22/10; C04B 22/106; C04B 24/267; C04B 24/38; C04B 28/04; C04B 40/0046; C04B 2103/32

(57) ABSTRACT

Embodiments of the present disclosure related compositions of pyrolysis char bricks and methods of making compositions of pyrolysis char bricks. The composition includes about 30% to about 80% PC, about 0% to about 30% sand, about 15% to about 60% cement material, and about 0.1% to about 10% additive. The method includes mixing the cement material, the pyrolysis char (PC), the sand, and the additive to form a dry mixture, and mixing a dry mixture with water to form a wet mixture. The method may further include transferring the wet mixture to a mold; curing the wet mixture to form a pyrolysis char brick (PCB); and demolding the PCB.

### BACKGROUND

### Field

Embodiments of the present disclosure generally relate to compositions for pyrolysis char bricks (PCBs) and methods of using the composition to fabricate PCBs.

### Description of Related Art

Coal currently serves an important role as an energy source but the increasing demand for renewable energy has reduced the production and consumption of coal in the United States of America (USA). Coal is carbon-rich, and its use in energy generation may affect atmospheric CO₂ levels. The air pollution and global environmental issues associated with the combustion of coal have limited the continuous application of coal in energy production. Specifically, according to the Bureau of Safety and Environmental Enforcement (BSEE), global warming results from various greenhouse gas emissions is partly due to fossil fuel burning, such as the combustion of coal. Therefore, several studies are being conducted to create new non-energy and fuel opportunities for Wyoming coal.

Wyoming serves as one of the major producers of coal in the USA. Wyoming Powder River Basin (PRB) coal plays an important role in the Wyoming energy industry. However, renewable energy is slowly replacing the coal industry, causing the market price of coal to drop. Thus, to attract new investment through technological innovation and support coal mine operations, environmentally friendly methods to create new diversified coal products are needed. One concern is characterizing the eco-efficiency of char products, which includes life-cycle metrics. In addition, the worldwide demand for bricks is rising, and is currently producing about 1,391 billion units. However, eco-friendly bricks suffer from various setbacks when comparing performance metrics to conventional clay bricks.

Therefore, there is a need for improved bricks derived from coal and methods of fabrication thereof.

### SUMMARY

In one embodiment, a composition includes about 30% to about 80% PC, about 0% to about 30% sand, about 15% to about 60% cement material, and about 0.1% to about 10% additive.

In another embodiment, a method includes mixing the cement material, the pyrolysis char (PC), the sand, and the additive to form a dry mixture, and mixing a dry mixture with water to form a wet mixture.

In yet another embodiment, a method includes mixing the cement material, the pyrolysis char (PC), the sand, and the additive to form a dry mixture, mixing a dry mixture with water to form a wet mixture; transferring the wet mixture to a mold; curing the wet mixture to form a pyrolysis char brick (PCB); and demolding the PCB.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a flow diagram of a method of forming pyrolysis char bricks (PCBs), according to embodiments.

FIG. 2 is a graph illustrating the compressive strength of the PCB samples, according to embodiments.

FIG. 3 is a graph illustrating the density of PCB samples at different sand and cement material contents, according to embodiments.

FIG. 4 is a graph of the compressive strengths of the PCBs samples at different sand and cement material contents, according to embodiments.

FIG. 5 is a graph illustrating the compressive strength of the starch-containing PCB samples, according to embodiments.

FIG. 6 is a graph illustrating the density of the alkaline-containing PCB samples, according to embodiments.

FIG. 7 is a graph illustrating the thermal conductivity of the alkaline-containing PCB samples, according to embodiments.

FIG. 8 is a graph illustrating the compressive strength of the alkaline-containing PCB samples, according to embodiments.

FIG. 9 is a graph illustrating the comparative compressive strengths of the admixture PCB samples, according to embodiments.

FIG. 10 is a graph illustrating the density of the superplasticizer-containing PCB (SPCB) samples, according to embodiments.

FIG. 11 is a graph illustrating the compressive strength of the SPCB samples, according to embodiments.

FIG. 12 is a graph illustrating the density of the fiber-containing PCB (FPCB) samples, according to embodiments.

FIG. 13 is a graph illustrating the compressive of the FPCB samples, according to embodiments.

FIG. 14 is a graph illustrating the density of the pre-pressed superplasticizer-containing PCB (PSPCB) samples, according to embodiments.

FIG. 15 is a graph illustrating the compressive strength of the PSPCB samples, according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to compositions and methods of using the composition to fabricate char bricks. In one embodiment, a composition is described herein. In another embodiment, a method of forming the composition is described herein. In another embodiment, a method of forming a pyrolysis char brick (PCB) from the composition is described herein.

The inventors have found new and improved methods for fabricating bricks from raw coal by mixing pyrolysis char (PC) with additives to replace sand and improve physical properties. Briefly, raw coal is thermo-chemically converted to produce pyrolysis char, and the resulting pyrolysis char is then converted to pyrolysis char bricks (PCBs).

The desire for environmentally-friendly materials, energy savings, and reduced energy consumption in building materials can be addressed by the building materials described herein. Building materials made with pyrolysis char (PC) have reduced density, increased strength, reduced thermal conductivity, and increased insulative properties when compared to conventional materials, such as clay bricks. There materials, trough recycling/reuse and decreasing the amount of energy usage in fabrication, further lessens the environmental impact of the PCBs.

The use of headings is for purposes of convenience and does not limit the scope of the present disclosure. Embodiments described herein can be combined with other embodiments.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

### Compositions

Embodiments described herein generally relate to a composition and methods of forming a composition formed using pyrolysis char (PC). The composition may be used to form pyrolysis char bricks (PCBs)

The PCBs include PC, a cement material, sand, and water. The PC, cement material, and sand make a mixture of dry ingredients. In some embodiments, the dry mixture further includes an additive. In other embodiments, the sand is replaced by the additive. The additive may include a starch material, an alkaline material, a superplasticizer material, or a fiber material. The mixture of dry ingredients include about 30% to about 80% PC, about 0% to about 30% sand, about 15% to about 60% cement material, and about 0.1% to about 10% additive by weight.

In some embodiments, the starch material may include a cornstarch. In some embodiments, the alkaline material may include a sodium bicarbonate (NaHCO₃), sodium carbonate (Na₂CO₃), sodium hydroxide (NaOH), calcium hydroxide (Ca(OH)₂), or a combination thereof. In some embodiments, the superplasticizer material may include a polycarboxylate superplasticizer (e.g., BASF Melflux®), a poly-carboxylic ether, sulphonated melamine formaldehyde, sulphonated naphthalene formaldehyde, and modified lignosulphonates, or a combination thereof. In some embodiments, the fiber material may include a polypropylene fiber, polyethylene fiber, glass fiber, or a combination thereof.

The PCBs have a compressive strength of about 2 MPa to about 20 MPa. The average density of the PCBs is from about 0.5 g/cm³ 1.5 g/cm³. Conventional clay bricks have a density of about 2.18 g/cm³. By decreasing the density of the PCBs as compared to conventional clay bricks, the monetary cost and environmental cost of transporting building materials may be decreased. The PCBs have a thermal conductivity from about 0.1 W/m·K to about 0.5 W/m·K. Conventional clay bricks typically have a thermal conductivity value between about 0.5 W/m·K and about 1.0 W/m·K. A low thermal conductivity value indicates an increased ability to provide insulation properties. The PCBs have a lower thermal conductivity than conventional clay bricks, thus making them preferable in terms of insulation qualities in construction projects.

PC is a solid residue from a pyrolysis process of coal. The cement material acts as a binder. The cement material includes ordinary Portland cement (OPC). The standard specifications for the OPC can be found in ASTM C150. The sand may be coarse aggregate (e.g., a grain size from about 10 mm to about 63 mm in diameter) or fine aggregate (less than about 8 mm in diameter). The sand includes generally coarse sand with particle sizes of 2-4.75 mm (hereinafter SA1), an ultra-fine garnet grit sand with particle sizes of 0.125-0.25 mm (hereinafter SA2), and filter blast line and well-graded sand with particle sizes of 0.2-2.5 mm (hereinafter SA3).

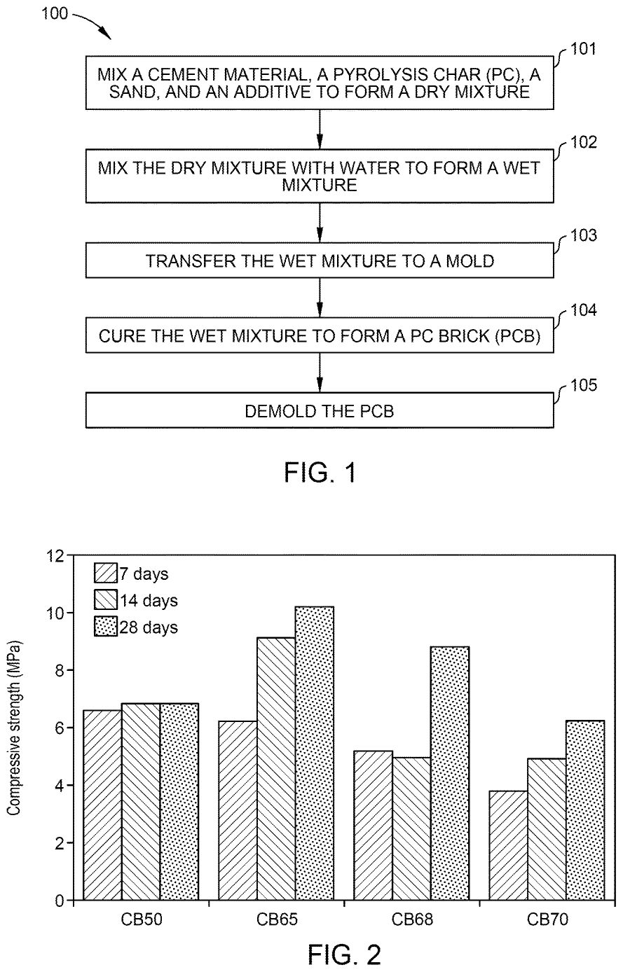

FIG. 1 illustrates a flow diagram of a method 100 of forming pyrolysis char bricks (PCBs). At operation 101, a cement material, pyrolysis char (PC), and sand are mixed to form a dry mixture. In some embodiments, the cement material, PC, and sand are mixed with an additive to form the dry mixture. In other embodiments, the sand is replaced with the additive. The additives include a starch material, an alkaline material, a superplasticizer material, or a fiber material. The cement material, PC, sand, and additives are mixed from about 30 seconds to about 120 seconds, such as about 60 seconds.

In some embodiments, the dry mixture includes the starch material. The starch material may be activated at in water at a temperature of about 10° C. to about 30° C., such as 20° C. (e.g., room temperature). The starch material may include a cornstarch. In one embodiment, the starch material may be bonded to the PC prior to mixing the cement material, the PC, and the sand. The PC and starch material may be mixed by spraying water onto the mixture to form a bonded PC. The PC and starch material may be homogenously mixed for about 30 seconds to about 180 seconds. In some embodiments, the bonded PC may be pelletized through uniform rotation of the particles and the water spraying. The bonded PC pellets may be dried in a controlled environment between about 40° C. and about 150° C. The cement material and sand may be mixed with the bonded PC pellets to form the dry mixture. In some embodiments, the bonded PC pellets may be pre-coated with cement material prior to mixing with the sand and cement material to make the dry mixture. The bonded PC is mixed with cement material such that the cement to bonded PC ratio is between about 1:10 and 1:2, such as about 1:5. The mixture of cement material and bonded PC pellets is stirred for about 30 seconds to about 120 seconds at a temperature of about 10° C. to about 30° C., such as 20° C. (e.g., room temperature). The mixture of cement material and bonded PC pellets is sprayed with water and stirred to form coated PC (CPC) pellets. The coated CPC pellets are mixed with cement materials and sand to form the dry mixture. The dry mixture includes about 30% to about 80% bonded PC, with the starch material being about 0.1% to about 1% of the dry mixture.

In another embodiment, cement materials, PC, starch material, and sand are mixed to form the dry mixture. The starch material is about 0.1% to about 1% of the dry mixture.

In some embodiments, cement materials, PC, and a fiber material are mixed to form the dry mixture. The fiber material is a polypropylene (PP) fiber, a polyethylene fiber, a glass fiber, or combinations thereof. The PP fiber may made with virgin PP having an average length of about 10 mm to about 30 mm, a density of about 0.5 g/cm³ to about 1.5 g/cm³, an elastic modulus of about 2.5 GPa to about 3.5 GPa, and a tensile strength of about 0.1 GPa to about 0.5 GPa. The dry mixture may include about 1% to about 10% fiber material.

At operation 102, water is added to the dry mixture to form a wet mixture. The water to cement ratio of the wet mixture is about 1.0 to about 3.0. The wet mixture is mixed for about 3 minutes to about 7 minutes, such as for about 5 minutes. In some embodiments, a laboratory mixer is used to mix the wet mixture.

In some embodiments, the water may be mixture with an additive prior to being mixed with the dry mixture to form a wet admixture. The wet admixture is added to the dry mixture to form a wet mixture. The wet admixture may include water and an alkaline material, water and a starch material, water and a fly ash material, water and a superplasticizer, or a combination thereof. In one embodiment, the alkaline material may be mixed with the water for about 2 minutes to about 8 minutes to form the wet admixture. The alkaline material may include sodium bicarbonate (NaHCO₃), sodium carbonate (Na₂CO₃), sodium hydroxide (NaOH), calcium hydroxide (Ca(OH)₂), or a combination thereof. The alkaline material to cement mass ratio is about 0.2 for both NaHCO₃ and Na₂CO₃. In another embodiment, the alkaline material, the starch material, and the fly ash material are mixed with water for about 2 minutes to about 8 minutes to form the wet admixture. In yet another embodiment, a superplasticizer material may be mixed with water for about 2 minutes to about 8 minutes to form the wet admixture. The superplasticizer material may include a polycarboxylate superplasticizer (e.g., BASF Melflux®), a poly-carboxylic ether, sulphonated melamine formaldehyde, sulphonated naphthalene formaldehyde, and modified lignosulphonates, or a combination thereof. The superplasticizer material is about 0.1% to about 1% of the dry mixture.

At operation 103, the wet mixture is transferred to a mold. The wet mixture is transferred into a mold and air dried for about 24 to 48 hours. In some embodiments, the mold containing the wet mixture is placed on a vibration table. The vibration table vibrates the wet mixture for about 2 minutes to 8 minutes to consolidate the wet mixture. In some embodiments, the mold is tapped during the vibration to further consolidate the wet mixture. In some embodiments, the mold may be pre-pressed for about 30 second to about 90 seconds. The pre-pressing may occur at about 3 MPa to about 8 MPa.

At operation 104, the wet mixture is cured to form a pyrolysis char brick (PCB). The air dried wet mixture is cured in a wet room at about 10° C. to about 30° C., such as 20° C. (e.g., room temperature). The average density of the PCBs is from about 0.5 g/cm³ 1.5 g/cm³. At operation 105, the PCBs are demolded.

### Uses

Embodiments of the present disclosure also generally relate to uses of the compositions described herein. Compositions described herein can also be used for various applications.

Illustrative, but non-limiting, applications include concrete masonry units such as cinder blocks, breezeblocks, hollow blocks, concrete blocks, construction blocks, Besser blocks, clinker blocks, among other concrete masonry units.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used by some experimental errors and deviations should be accounted for.

### EXAMPLES

### Test Methods

The compressive strength of the PCBs was measured using Forney compression machine. The compressive strength of the PCBs was measured using ASTM C67.

The vibrating table is a Gilson Model HM-140 concrete vibration table.

The laboratory mixer is a stand mixer from McMaster-Carr.

The density is measured using Venier Caliper Model No. DCLA-0605 and lab balance scale Model. No. H-5853.

Pre-pressing is a Stongway 50-Ton Pneumatic Shop Press Model No. 46246.

Thermal conductivity is measured using Hot Disk Thermal Constants Analyzer 2500S. The thermal conductivity of the PCBs was measured using ISO 22007-2.

### Experimental

Table 1 shows a summary of the compositions of pyrolysis char brick (PCB) samples formed using method 100. The PC, cement material, and sand are mixed at about room temperature (~20° C.). Water is added to the dry mixture and stirred for 3 minutes to form the wet mixture. The wet mixture is air dried for 24 to 48 hours before curing. The wet mixture is cured in a wet room at room temperature (~20° C.) and relative humidity of 75%.

The PCB samples are made using different compositions e.g., a sample having a dry mixture of 50% PC, 25% cement material, and 25% sand (CB50); a dry mixture of 65% PC and 35% cement material (CB65); a dry mixture of 68% PC and 32% cement material (CB68); and a dry mixture of 70% PC and 30% cement material (CB70). By replacing the sand with PC, the average density of the resultant PCB samples drops below 1 g/cm³. Increasing the pyrolysis char contents from 50% to 70% further decreases the density of the PCBs further. Conventional clay bricks have a density of about 2.18 g/cm³. By decreasing the density of the PCBs, the monetary cost and environmental cost of transporting building materials may be decreased.

TABLE 1
Summary of PCB Compositions with Varying PC Amounts.

| Sample | | Cement | | Water-Cement | Average |
|---|---|---|---|---|---|
| ID | PC | Material | Sand | Ratio | Density (g/cm³) |
| CB50 | 50% | 25% | 25% | 2.0 | 1.03 |
| CB65 | 65% | 35% | 0% | 2.2 | 0.82 |
| CB68 | 68% | 32% | 0% | 2.2 | 0.80 |
| CB70 | 70% | 30% | 0% | 2.2 | 0.75 |

FIG. 2 is a graph illustrating the compressive strength of the PCB samples. The graph shows the compressive strength of the PCB samples at 7, 14 and 28 days after demolding. An increase of cement material content from 25% to 35% and replacing the sand with PC increases the compressive strength of the PCB. This demonstrates the feasibility of replacing sand with PC, and shows the importance of the binding material (e.g., the cement material). Increasing the PC from 65% to 70% decreases the compressive strengths at 7, 14, and 28 days.

Table 2 shows a summary of compositions of PCB samples formed using method 100. The cement material, PC, and sand are mixed for about 1 minute at room temperature (~20° C.) to form the dry mixture. Water is added to the dry mixture and stirred for about 5 minutes using a laboratory mixer. The wet mixture is transferred to molds and placed on a vibrating table for about 5 minutes. The wet mixture is air dried for about 24 hours. The wet mixture is cured in a wet room at room temperature (~20° C.) and relative humidity of 95%.

The PCB samples are made using different compositions e.g., a sample having a dry mixture of 70% pyrolysis char and 30% cement material (SA0); a dry mixture of 70% pyrolysis char, 2.5% SA1 sand, and 27.5% cement material (SA1-2.5); a dry mixture of 70% pyrolysis char, 5% SA1 sand, and 25% cement material (SA1-5); a dry mixture of 70% pyrolysis char, 2.5% SA2 sand, and 27.5% cement material (SA2-2.5); a dry mixture of 70% pyrolysis char, 5% SA2 sand, and 25% cement material (SA2-5); a dry mixture of 70% pyrolysis char, 2.5% SA3 sand, and 27.5% cement material (SA3-2.5); and a dry mixture of 70% pyrolysis char, 5% SA3 sand, and 25% cement material (SA3-5).

TABLE 2
Summary of PCB Samples with Varying Sand Types and Amounts.

| Sample | Sand particle | | Cement | | Water-Cement |
|---|---|---|---|---|---|
| ID | size (mm) | PC | Material | Sand | Ratio |
| SA0 | n/a | 70% | 30% | 0% | 2.2 |
| SA1-2.5 | 2-4.75 | | 27.5% | 2.5% | |
| SA1-5 | 2-4.75 | | 25% | 5% | |
| SA2-2.5 | 0.125-0.25 | | 27.5% | 2.5% | |
| SA2-5 | 0.125-0.25 | | 25% | 5% | |
| SA3-2.5 | 0.2-2.5 | | 27.5% | 2.5% | |
| SA3-5 | 0.2-2.5 | | 25% | 5% | |

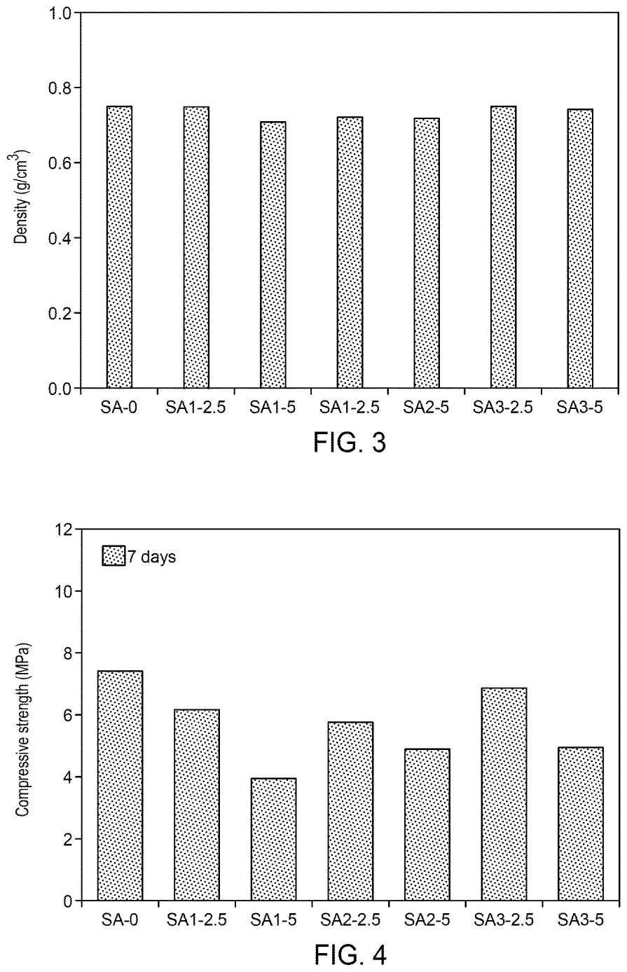

FIG. 3 is a graph illustrating the density of PCBs at different sand and cement material contents. The PCB samples cured for 7 days. The density of PCB samples ranges from 0.71 to 0.75 g/cm³, which are each less than 1 g/cm³. The comparison reveals that different sand types and relatively small sand contents have little to no effect on the density of the PCB samples. The use of 70% pyrolysis char will reduce the density of PCB samples below 1 g/cm³. By decreasing the density of the PCBs, the monetary cost and environmental cost of transporting building materials may be decreased.

FIG. 4 is a graph of the compressive strengths of the PCBs samples. The PCB samples have 70% PC at different sand and cement material contents. The graph shows that the increase in the sand content from 0% to 5% reduces compressive strengths of PCB samples by 47% for SA1, 34% for SA2, and 33% for SA3. The strength reduction is due to the lower cement material content serving as the binder to the higher sand content. The compressive strengths of PCB samples with the filter and well-graded sand SA3 are relatively higher than that of the coarse sand SA1 and the ultrafine sand SA2 due to the filler effect from SA3 in PCB samples.

Table 3 shows a summary of compositions of starch-bonded PCBs formed using method 100 having starch bonded PC. A corn-starch powder is activated in water at about room temperature (~20° C.). The PC is mixed with the corn-starch powder while spraying a controlled amount of water on the mixture to form a bonded PC. The bonded PC is rotated to control the formation of the pellet, the size of the pellet, and to ensure the PC is bonded to the corn-starch powder. The PC and corn-starch are mixed for about 1 minute to about 2 minutes. The bonded PC is dried at a temperature of about 40° C. to about 150° C. The bonded PC is pre-coated with cement material. The bonded PC is mixed with 20% cement material (cement/bonded PC ratio of 1:5). The mixture is stirred for about 60 seconds to ensure pellet formation. The pre-coated bonded PC is mixed with cement material and sand at room temperature (~20° C.) for about 120 seconds to create the dry mixture. Water is mixed with the dry mixture for about 180 seconds. The PC-40 and PC-150 samples includes 75% bonded PC by weight. The wet mixture is transferred into a mold and air dried for about 24 to 48 hours. The air dried wet mixture is cured in a wet room at about room temperature (~20° C.). The PCBs samples are made using different compositions, e.g., a sample having a pelletized starch-bonded PC dried at 40° C. (PC-40) and a sample having a pelletized starch-bonded PC dried at 150° C. (PC-150).

TABLE 3
Summary of Compositions of Starch-Bonded PCB Samples.

| Sample ID | Starch-bonded PC | Cement | Sand aggregate |
|---|---|---|---|
| Bonded PC-40 | 75% | 15% | 10% |
| Bonded PC-150 | 75% | 15% | 10% |

Table 4 shows a summary of the density and compressive strength of PCBs made from the starch-bonded PC samples. The density ranges from about 0.8 g/cm³ to about 1.1 g/cm³. Conventional clay bricks have a density of about 2.18 g/cm³. By decreasing the density of the PCBs, the monetary cost and environmental cost of transporting building materials may be decreased.

The PCBs using starch-bonded PC dried at 40° C. had higher strength than the PCBs using starch-bonded PC dried at 150° C. The relatively lower compressive strength of the starch-bonded PCBs demonstrates that the cement material content of 15% is insufficient to bind the 85% of starch bonded-PC and sand. However, by decreasing the PC content, improved mechanical properties may be achieved.

TABLE 4
Summary of Density and Compressive Strength
of Starch-Bonded PCB Samples.

| | Curing | Density | Compressive |
|---|---|---|---|
| Sample ID | time (day) | (g/cm³) | strength (MPa) |
| Bonded PC-40 | 7 | 0.91 | 1.97 |
| Bonded PC-150 | | 0.87 | 0.10 |
| Bonded PC-40 | 14 | 0.89 | 2.21 |
| Bonded PC-150 | | 1.01 | 0.73 |

Table 5 shows a summary of compositions of starch-containing PCBs formed using method 100 having a starch material. Cement materials, PC, starch material, and sand are weighed and mixed using a laboratory mixture for about 1 minute at room temperature (~20° C.) to form the dry mixture. Water is added to the dry mixture and stirred for about 5 minutes to form the wet mixture. The wet mixture is transferred to molds and air dried for about 24 hours. The wet mixture is then cured in a wet room at room temperature (~20° C.) and a humidity of about 75% to form starch-containing PCBs.

The starch-bonded PCB samples are made using different compositions e.g., a sample having a dry mixture of 50% PC and 0% starch material (CB₅₀-ST₀); a sample having a dry mixture of 50% PC and 0.6% starch material (CB₅₀-ST_{0.6}); a sample having a dry mixture of 60% PC and 0.6% starch material (CB₆₀-ST_{0.6}); and a sample having a dry mixture of 70% PC and 0.6% starch material (CB₇₀-ST_{0.6}).

TABLE 5
Summary of Compositions of Starch-Containing PCB Samples.

| | | Cement | | | Water-Cement |
|---|---|---|---|---|---|
| Sample ID | PC | Material | Starch | Sand | Ratio |
| CB₅₀-ST₀ | 50% | 25% | 0.0% | 25% | 2 |
| CB₅₀-ST_{0.6} | 50% | 24.4% | 0.6% | 25% | 2 |
| CB₆₀-ST_{0.6} | 60% | 25% | 0.6% | 14.4% | 2.4 |
| CB₇₀-ST_{0.6} | 70% | 25% | 0.6% | 4.4% | 2.7 |

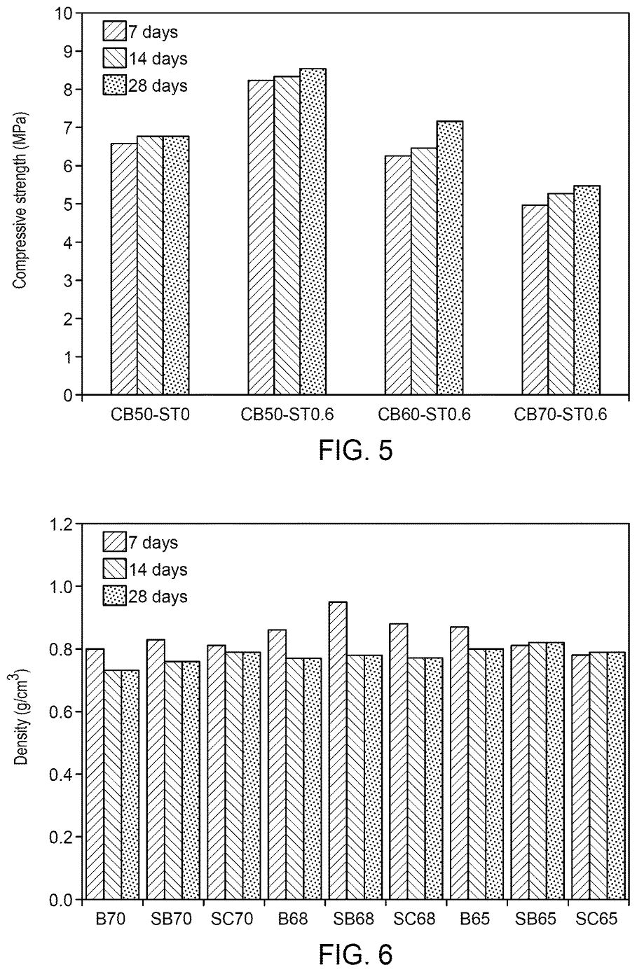

FIG. 5 is a graph illustrating the compressive strength of the starch-containing PCB samples. The addition of starch material increases the compressive strength of the PCB, on average, by 25%.

Table 6 shows a summary of compositions of alkaline-containing PCBs formed using method 100 having an alkaline material. PC and cement materials are mixed using a laboratory mixer for about 5 minutes to form a dry mixture. An alkaline material is mixed with water for about 5 minutes to form a wet admixture. The alkaline material may be sodium bicarbonate (NaHCO₃) or sodium carbonate (Na₂CO₃). The dry mixture and wet admixture are mixed using the laboratory mixture for about 5 minutes to form a wet mixture. The alkaline material to cement material mass ratio is about 0.2 for both NaHCO₃ and Na₂CO₃. The wet mixture is transferred to a mold and placed on a vibration table. The wet mixture is vibrated on the vibration table for about 7 minutes to consolidate the wet mixture. The wet mixture is stores at about room temperature (~20° C.) for about 24 hours. The wet mixture is then demolded and cured in a wet room at room temperature (~20° C.) and a humidity of about 95% to for alkaline-containing PCBs.

The alkaline-containing PCB samples are made using different compositions e.g., a sample having a dry mixture 70% PC, 30% cement materials, and no alkaline materials (B70); a sample having a dry mixture 70% PC, 30% cement materials, and NaHCO₃ (SB70); a sample having a dry mixture 70% PC, 30% cement materials, and Na₂CO₃ (SC70); a sample having a dry mixture 68% PC, 30% cement materials, and no alkaline materials (B68); a sample having a dry mixture 68% PC, 30% cement materials, and NaHCO₃(SB68); a sample having a dry mixture 68% PC, 30% cement materials, and Na₂CO₃ (SC68); a sample having a dry mixture 65% PC, 30% cement materials, and no alkaline materials (B65); a sample having a dry mixture 65% PC, 30% cement materials, and NaHCO₃(SB65); a sample having a dry mixture 65% PC, 30% cement materials, and Na₂CO₃ (SC65).

TABLE 6
Summary of Compositions of Alkaline-Containing PCB Samples.

| | | Cement | | Water-Cement | Alkali-Cement |
|---|---|---|---|---|---|
| Sample ID | PC | Material | Alkali | Ratio | Mass Ratio |
| B70 | 70% | 30% | — | 2.2 | 0 |
| SB70 | 70% | 30% | NaHCO₃ | 2.2 | 0.2 |
| SC70 | 70% | 30% | Na₂CO₃ | 2.2 | 0.2 |
| B68 | 68% | 32% | — | 2.2 | 0 |
| SB68 | 68% | 32% | NaHCO₃ | 2.2 | 0.2 |
| SC68 | 68% | 32% | Na₂CO₃ | 2.2 | 0.1 |
| B65 | 65% | 35% | — | 2.2 | 0 |
| SB65 | 65% | 35% | NaHCO₃ | 2.2 | 0.2 |
| SC65 | 65% | 35% | Na₂CO₃ | 2.2 | 0.1 |

FIG. 6 is a graph illustrating the density of the alkaline-containing PCB samples. The densities range from 0.7 g/cm³ to about 1.0 g/cm³. The density of the alkaline-containing PCB samples is less than 1.0 g/cm³ due to the high PC content and absence of sand. Conventional clay bricks have a density of about 2.18 g/cm³. By decreasing the density of the PCBs, the monetary cost and environmental cost of transporting building materials may be decreased.

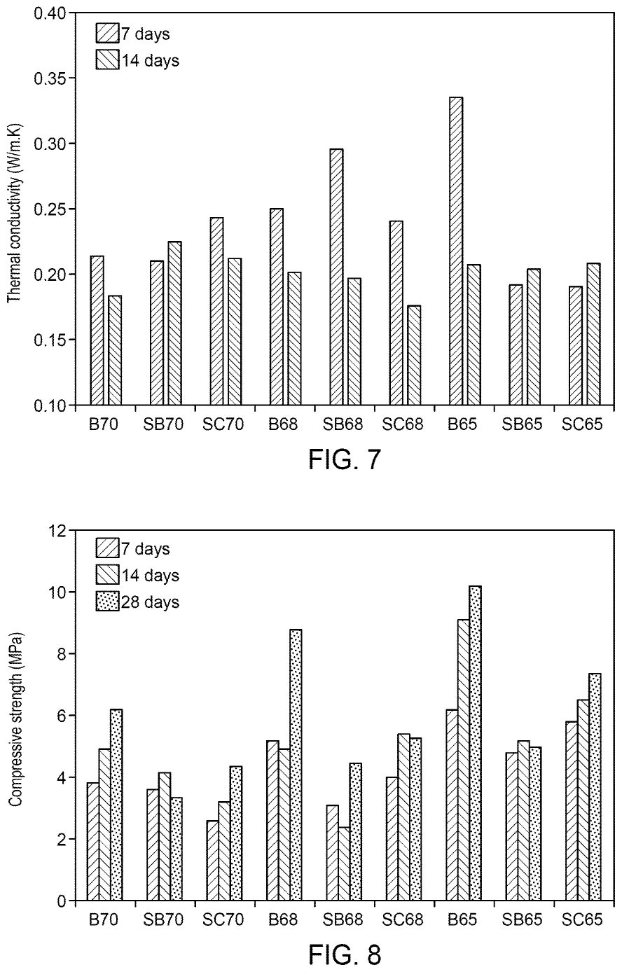

FIG. 7 is a graph illustrating the thermal conductivity of the alkaline-containing PCB samples. The thermal conductivity of the alkaline-containing PCB samples ranges from 0.18 W/m·K to about 0.35 W/m·K. Conventional clay bricks typically have a thermal conductivity value between about 0.5 W/m·K and about 1.0 W/m·K. A low thermal conductivity value indicates an increased ability to provide insulation properties. The alkaline-containing PCBs have a lower thermal conductivity than conventional clay bricks, thus making them preferable in terms of insulation qualities in construction projects.

FIG. 8 is a graph illustrating the compressive strength of the alkaline-containing PCB samples. Decreasing the PC content of the alkaline-containing PCB samples increases the compressive strength of the alkaline PCB samples. At the same PC content, the compressive strength of the alkaline-containing PCBs was lower than the PCBs without alkaline materials. This is due the high alkaline content, which caused the formation of strong alkali (e.g., sodium hydroxide) in the sample, hindering strength development. By decreasing the alkaline material content, an increase in strength may occur.

Table 7 shows a summary of compositions of alkaline material/starch material/fly ash material-containing PCB (ASF-PCB) samples formed using method 100 having an alkaline material, starch material, and fly ash material. PC and cement materials are mixed using a laboratory mixer for about 5 minutes to form a dry mixture. An alkaline material, starch material, and fly ash material are mixed with water for about 5 minutes to form a wet admixture. The alkaline material may be sodium bicarbonate (NaHCO₃) or sodium carbonate (Na₂CO₃). The dry mixture and wet admixture are mixed using the laboratory mixture for about 5 minutes to for a wet mixture. The wet mixture is transferred to a mold and placed on a vibration table. The wet mixture is vibrated on the vibration table for about 7 minutes to consolidate the wet mixture. The wet mixture is air dried at about room temperature (~20° C.) for about 24 hours. The wet mixture is then demolded and cured in a wet room at room temperature (~20° C.) and a humidity of about 95% to form ASF-PCB samples. The ASF-PCB samples have about 69.6% PC, about 24.5% cement materials, about 0.5% starch material, 4.4% fly ash, and about 1% Na₂CO₃ (CB70-ST-FA-SC).

TABLE 7
Summary of Composition of the ASF-PCB Samples.

| | | Cement | | Fly | | Water-Cement |
|---|---|---|---|---|---|---|
| Sample | PC | Material | Starch | ash | Na₂CO₃ | Ratio |
| CB70-ST-FA-SC | 69.6% | 24.5% | 0.5% | 4.4% | 1% | 2.2 |

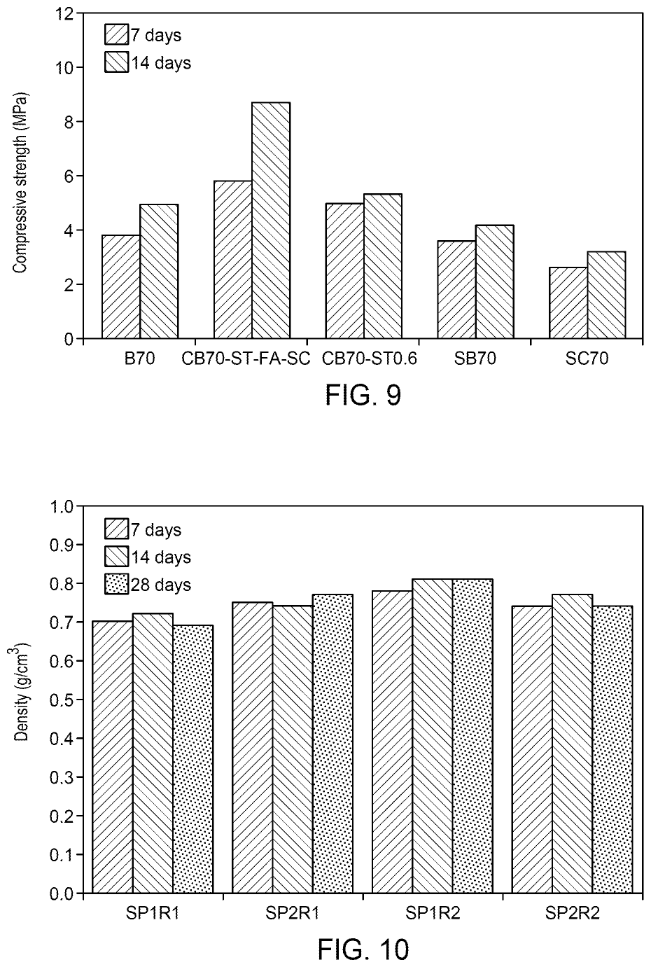

FIG. 9 is a graph illustrating the comparative compressive strengths of the admixture PCB samples. The ASF-PCB sample had increased compressive strength compared to the B70, CB₇₀-ST_{0.6}, SB 70, and SC70 samples at both 7-day and 14-day curing times. The use of the various admixtures, therefore, may enable increases in the compressive strength of the resultant PCBs.

Table 8 shows a summary of compositions of superplasticizer PCB (SPCBs) samples formed using method 100 having a superplasticizer material. Water is mixed with a superplasticizer material for five minutes to form a wet admixture. The superplasticizer material may be a BASF Melflux® (SP1) in powder form or a poly-carboxylic ether (SP2). PC and cement material are mixed for about a minute to form the dry mixture. The wet admixture and the dry mixture are mixed using a laboratory mixer for about five minutes to form a wet mixture. After mixing, the wet mixture is transferred to a mold, placed on a vibration table, and vibrated and tapped for about five minutes. The wet mixture is initially covered with a plastic membrane and cured for about 24 hours at about room temperature (~20° C.). The wet mixture is demolded and cured in a wet room at about 25° C. and 75% humidity to form SPCB samples.

The SPCB samples are made using different compositions e.g., a sample having a dry mixture of 70% PC, 29.4% cement material, 0.6% SP1, and a water to cement material ratio of 2.1 (SP1R1); a sample having a dry mixture of 70% PC, 29.4% cement material, 0.6% SP2, and a water to cement material ratio of 2.1 (SP2R1); a sample having a dry mixture of 70% PC, 29.4% cement material, 0.6% SP1, and a water to cement material ratio of 2.0 (SP1R2); a sample having a dry mixture of 70% PC, 29.4% cement material, 0.6% SP1, and a water to cement material ratio of 2.0 (SP1R2).

TABLE 8
Summary of Composition of the SPCB Samples.

| Sample ID | PC | Cement | SP | Water-Cement Ratio |
|---|---|---|---|---|
| SP1R1 | 70% | 29.4% | SP1 | 2.1 |
| SP2R1 | 70% | 29.4% | SP2 | 2.1 |
| SP1R2 | 70% | 29.4% | SP1 | 2.0 |
| SP2R2 | 70% | 29.4% | SP2 | 2.0 |

FIG. 10 is a graph illustrating the density of the SPCB samples. All of the SPCB samples have densities less than 1 g/cm³. By tapping the molds, the density of the SPCBs may be increased. Conventional clay bricks have a density of about 2.18 g/cm³. By decreasing the density of the PCBs, the monetary cost and environmental cost of transporting building materials may be decreased.

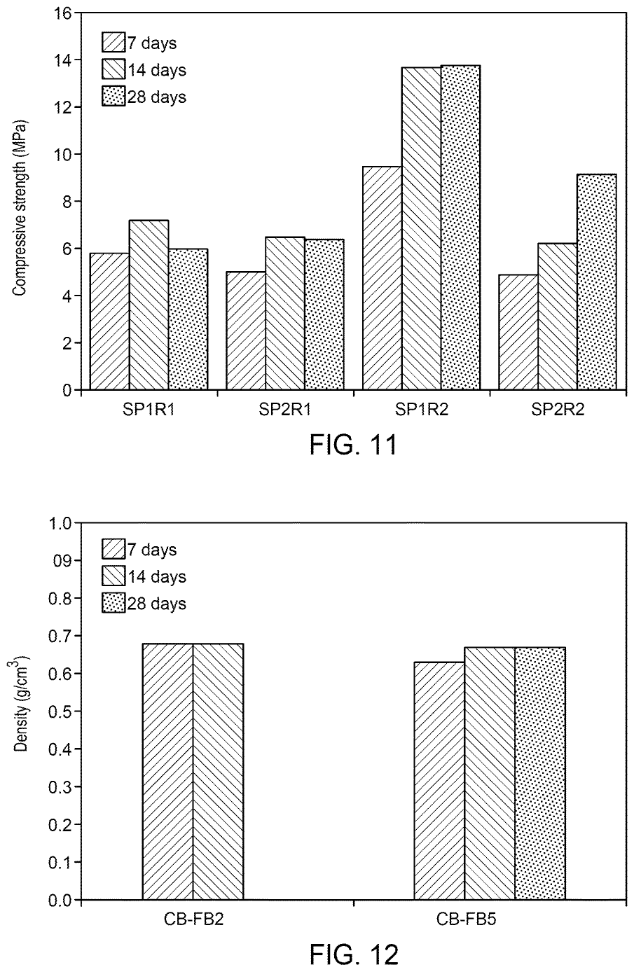

FIG. 11 is a graph illustrating the compressive strength of the SPCB samples. The SPCB samples exhibited increased compressive strengths when compared to PCBs without admixtures (e.g., B70). Reducing the water to cement material ratio increases the compressive strength without effecting workability of the SPCB samples. In addition, tapping the molds during the vibration process increased the compressive strengths at all curing times. SP1 exhibited higher compressive strengths than SP2.

Table 9 shows a summary of compositions of fiber PCBs (FPCB) samples formed using method 100 having a fiber material. PC, cement material, and fiber material are mixed at about room temperature (~20° C.) for about 1 minute to form a dry mixture. The fiber material is a polypropylene (PP) fiber. The PP fiber is made with virgin PP having an average length of about 19 mm, a density of 0.9 g/cm³, an elastic modulus of about 3.45 GPa, and a tensile strength of about 0.29 GPa. Water is added to the dry mixture and mixed for about 5 minutes using a laboratory mixer to form a wet mixture. The wet mixture is transferred to a mold and placed on a vibrating table. The wet mixture is vibrated on the vibration table for about 5 minutes. The wet mixture is air dried at about room temperature (~20° C.) for about 24 hours. The wet mixture is then cured in a wet room for about 24 hours to form FPCB samples.

The FPCB samples are made using different compositions e.g., a sample having a dry mixture of 70% PC, 28% cement materials, and 2% fiber material; and a sample having a dry mixture of 70% PC, 25% cement materials, and 5% fiber material.

TABLE 9
Summary of Composition of the FPCB Samples.

| Sample | | Cement | | Water-Cement |
|---|---|---|---|---|
| ID | PC | Material | Fiber | Ratio |
| CB-FB2 | 70% | 28% | 2% | 3 |
| CB-FB5 | 70% | 25% | 5% | 4.3 |

FIG. 12 is a graph illustrating the density of the FPCB samples. The FPCB samples have a density less than about 0.7 g/cm³. Increasing the amount of PP fiber does not increase the density, but reduces the density due to the decrease in cement material content. The density is independent of the curing duration. Conventional clay bricks have a density of about 2.18 g/cm³. By decreasing the density of the PCBs, the monetary cost and environmental cost of transporting building materials may be decreased.

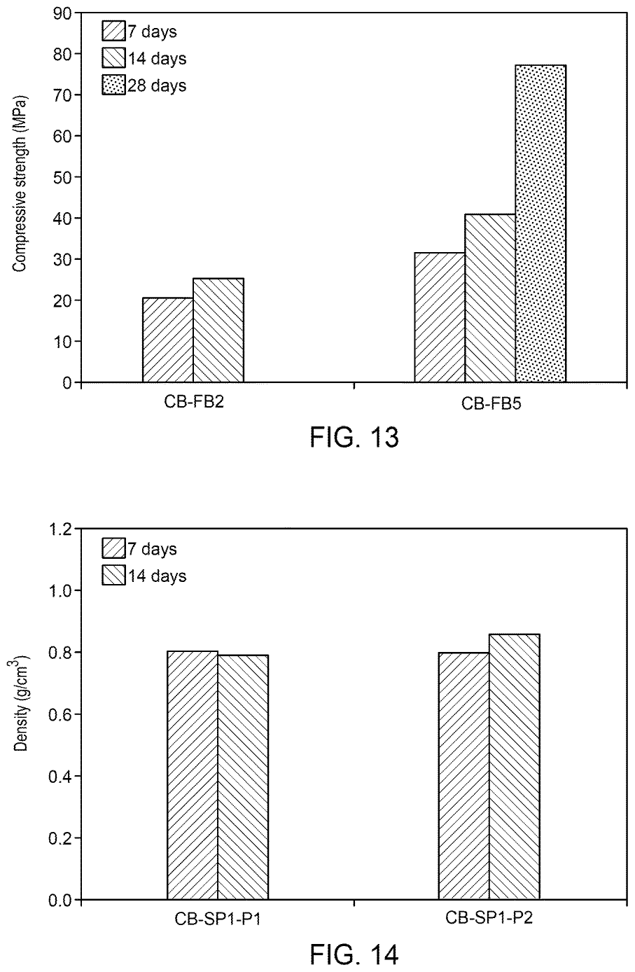

FIG. 13 is a graph illustrating the compressive of the FPCB samples. The compressive FPCB samples is greater than other PCB samples described above (e.g., starch material, alkaline material, and superplasticizer material). The 7-day compressive strength of the FPCB samples exceed 20 MPa. The compressive strength increases with the curing time and PP fiber content.

Table 10 is a summary of compositions of pre-pressed superplasticizer PCBs (PSPCB) samples formed using method 100 having a superplasticizer material. Water is mixed with a superplasticizer material for five minutes to form a wet admixture. The superplasticizer material may be a BASF Melflux® (SP1) in powder form. PC and cement material are mixed for about a minute to form the dry mixture. The wet admixture and the dry mixture are mixed using a laboratory mixer for about five minutes to form a wet mixture. After mixing, the wet mixture is transferred to a mold. The mold is pre-pressed for about one minute at about 3 MPa to about 8 MPa. The wet mixture is initially covered with a plastic membrane and cured for about 24 hours at about room temperature (~20° C.). The wet mixture is demolded and cured in a wet room at about 25° C. and 75% humidity to form SPCB samples.

The PSPCB samples are made using different compositions e.g., a sample having a dry mixture of 69.5% PC, 29.9% cement materials, 0.6% SP1, and pre-pressed at a pressure of 3.6 MPa (P1) (CB-SP1-P1); a sample having a dry mixture of 69.5% PC, 29.9% cement materials, 0.6% SP1, and pre-pressed at a pressure of 7.2 MPa (P2) (CB-SP1-P2).

TABLE 10
Summary of Composition of the PSPCB Samples.

| | | Cement | | Water-Cement | Prepressing |
|---|---|---|---|---|---|
| Sample ID | PC | Material | SP | Ratio | Pressure (MPa) |
| CB-SP1-P1 | 69.5% | 29.9% | 0.6% | 1.7 | 3.6 |
| CB-SP1-P2 | 69.5% | 29.9% | 0.6% | 1.7 | 7.2 |

FIG. 14 is a graph illustrating the density of the PSPCB samples. The density of PSPCB samples less than 1 g/cm³. Conventional clay bricks have a density of about 2.18 g/cm³. By decreasing the density of the PCBs, the monetary cost and environmental cost of transporting building materials may be decreased. A lower water to cement material ratio of 1.7 is used to prepare a moist mixture and eliminate moisture loss from the pre-pressing process.

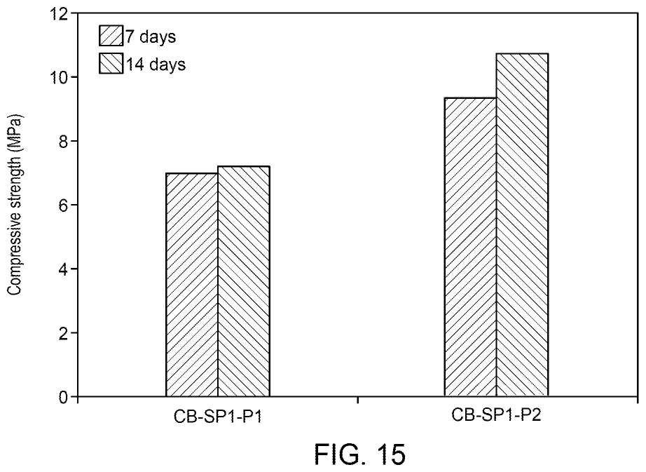

FIG. 15 is a graph illustrating the compressive strength of the PSPCB samples. The CB-SP1-P2 samples increases the compressive strength of the PSPCB samples when compared against the SPCB samples. The higher pre-pressing pressure enables increases in the compressive strength of the SPCBs.

### EMBODIMENTS LISTING

The present disclosure provides, among other things, the following embodiments, each of which can be considered as optionally including any alternate embodiment.

Clause 1. A composition, comprising:
about 30% to about 80% PC;
about 0% to about 30% sand;
about 15% to about 60% cement material; and
about 0.1% to about 10% additive.

Clause 2. The composition of clause 1, wherein the additive comprises a starch material, an alkaline material, a superplasticizer material, a fiber material, or combinations thereof.

Clause 3. The composition of clause 2, wherein the starch material comprises a corn-starch.

Clause 4. The composition of clause 2, wherein alkaline material comprises sodium bicarbonate (NaHCO₃), sodium carbonate (Na₂CO₃), sodium hydroxide (NaOH), calcium hydroxide (Ca(OH)₂), or combinations thereof.

Clause 5. The composition of clause 2, wherein the superplasticizer material comprises a polycarboxylate superplasticizer, a poly-carboxylic ether, sulphonated melamine formaldehyde, sulphonated naphthalene formaldehyde, and modified lignosulphonates, or combinations thereof.

Clause 6. The composition of clause 2, wherein the fiber material comprises a polypropylene fiber, polyethylene fiber, glass fiber, or combinations thereof.

Clause 7. The composition of clause 1, wherein the cement material is ordinary Portland cement (OPC).

Clause 8. The composition of clause 1, wherein the sand comprises coarse aggregate or fine aggregate.

Clause 9. The composition of clause 1, wherein the PC comprises coarse aggregate or fine aggregate.

Clause 10. A method of making a composition, comprising:
mixing a cement material, a pyrolysis char (PC), sand, and an additive to form a dry mixture, wherein the composition comprises:
   about 30% to about 80% PC;
   about 0% to about 30% sand;
   about 15% to about 60% cement material; and
   about 0.1% to about 10% additive; and
mixing a dry mixture with water to form a wet mixture.

Clause 11. The method of clause 10, wherein the water is mixed with the additive to form a wet admixture prior to mixing with the dry mixture to form the wet mixture.

Clause 12. The method of clause 10, wherein the additive comprises a starch material, an alkaline material, a superplasticizer material, a fiber material, a fly ash material, or combinations thereof.

Clause 13. The composition of clause 12, wherein the starch material comprises a corn-starch.

Clause 14. The method of clause 13, wherein the starch material may be bonded to the PC to form a bonded PC prior to mixing the cement material, the PC, and the sand to make the dry mixture.

Clause 15. The method of clause 14, wherein the bonded PC may be pelletized through uniform rotation of the particles and the water spraying.

Clause 16. The method of clause 15, wherein the bonded PC pellets may be pre-coated with cement material prior to mixing with the sand and cement material to make the dry mixture.

Clause 17. The composition of clause 12, wherein alkaline material comprises sodium bicarbonate (NaHCO₃), sodium carbonate (Na₂CO₃), sodium hydroxide (NaOH), calcium hydroxide (Ca(OH)₂), or combinations thereof.

Clause 18. The method of clause 17, wherein the alkaline material is mixed with water prior to mixing the dry mixture with the water.

Clause 19. The method of clause 17, wherein the alkaline material, the starch material, and the fly ash material is mixed with water prior to mixing the dry mixture with the water.

Clause 20. The composition of clause 12, wherein the superplasticizer material comprises a polycarboxylate superplasticizer, a poly-carboxylic ether, sulphonated melamine formaldehyde, sulphonated naphthalene formaldehyde, and modified lignosulphonates, or combinations thereof.

Clause 21. The method of clause 20, wherein the superplasticizer is mixed with water prior to mixing the dry mixture with the water.

Clause 22. The composition of clause 12, wherein the fiber material comprises a polypropylene fiber, polyethylene fiber, glass fiber, or combinations thereof.

Clause 23. The composition of clause 10, wherein the cement material is ordinary Portland cement (OPC).

Clause 24. The composition of clause 10, wherein the sand comprises coarse aggregate or fine aggregate.

Clause 25. The composition of clause 10, wherein the PC comprises coarse aggregate or fine aggregate.

Clause 26. The method of clause 10, wherein the cement material, the pyrolysis char (PC), the sand, and the additive are mixed for about 30 seconds to about 120 second to form the dry mixture.

Clause 27. The method of clause 10, wherein the water to cement ratio of the wet mixture is about 1.0 to about 3.0.

Clause 28. The method of clause 10, wherein the dry mixture is mixed with water for about 3 minutes to about 7 minutes.

Clause 29. The method of clause 10-28, further comprising:
transferring the wet mixture to a mold;
curing the wet mixture to form a pyrolysis char brick (PCB);
demolding the PCB.

Clause 30. The method of clause 29, further comprising:
placing the wet mixture in the mold on a vibration table; and
vibrating the wet mixture in the mold is mixed with water for about 2 minutes to 8 minutes.

Clause 31. The method of clause 30, further comprising tapping the mold containing the wet mixture.

Clause 32. The method of clause 11, further comprising pre-pressing the wet mixture in the mold.

Clause 33. The method of clause 32, wherein the pre-pressing occurs at about 3 MPa to about 8 MPa.

Clause 34. The method of clause 11, wherein the wet mixture is cured at about 10° C. to about 30° C.

Clause 34. The method of clause 11, wherein the PCBs have a density of about 0.5 g/cm³ 1.5 g/cm³.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, process operation, process operations, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, process operation, process operations, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

While the foregoing is directed to embodiments of the present disclosure, other and further embodiments of the disclosure may be devised without departing from the basic scope thereof.

What is claimed is:

1. A composition, comprising:
about 30% to about 80% PC;
about 0% to about 30% sand;
about 15% to about 60% cement material; and
about 0.1% to about 10% additive.

2. The composition of claim 1, wherein the additive comprises a starch material, an alkaline material, a superplasticizer material, a fiber material, or combinations thereof.

3. The composition of claim 2, wherein the starch material comprises a corn-starch.

4. The composition of claim 2, wherein alkaline material comprises sodium bicarbonate (NaHCO₃), sodium carbonate (Na₂CO₃), sodium hydroxide (NaOH), calcium hydroxide (Ca(OH)₂), or combinations thereof.

5. The composition of claim 2, wherein the superplasticizer material comprises a polycarboxylate superplasticizer, a poly-carboxylic ether, sulphonated melamine formaldehyde, sulphonated naphthalene formaldehyde, and modified lignosulphonates, or combinations thereof.

6. The composition of claim 2, wherein the fiber material comprises a polypropylene fiber, a polyethylene fiber, glass fiber, or combinations thereof.

7. A method of making a composition, comprising:
mixing a cement material, a pyrolysis char (PC), sand, and an additive to form a dry mixture, wherein the composition comprises:
about 30% to about 80% PC;
about 0% to about 30% sand;
about 15% to about 60% cement material; and
about 0.1% to about 10% additive; and
mixing a dry mixture with water to form a wet mixture.

8. The method of claim 7, wherein the water is mixed with the additive to form a wet admixture prior to mixing with the dry mixture to form the wet mixture.

9. The method of claim 8, wherein the additive comprises a starch material, an alkaline material, a superplasticizer material, a fiber material, a fly ash material, or combinations thereof.

10. The method of claim 9, wherein the starch material may be bonded to the PC to form a bonded PC prior to mixing the cement material, the PC, and the sand to make the dry mixture.

11. The method of claim 10, wherein the bonded PC may be pre-coated with cement material prior to mixing with the sand and cement material to make the dry mixture.

12. The method of claim 9, wherein the alkaline material, the starch material, and the fly ash material is mixed with water prior to mixing the dry mixture with the water.

13. The method of claim 9, wherein the superplasticizer is mixed with water prior to mixing the dry mixture with the water.

14. A method of making a composition, comprising:
mixing a cement material, a pyrolysis char (PC), sand, and an additive to form a dry mixture, wherein the composition comprises:
about 30% to about 80% PC;
about 0% to about 30% sand;
about 15% to about 60% cement material; and
about 0.1% to about 10% additive; and
mixing a dry mixture with water to form a wet mixture;
transferring the wet mixture to a mold;
curing the wet mixture to form a pyrolysis char brick (PCB); and
demolding the PCB.

15. The method of claim 14, further comprising:
placing the wet mixture in the mold on a vibration table; and
vibrating the wet mixture in the mold is mixed with water for about 2 minutes to 8 minutes.
